(19) United States
(12) Patent Application Publication
(10) Pub. No.: US 2015/0057145 A1
(43) Pub. Date: Feb. 26, 2015

(54) SILICOTHERMIC REDUCTION OF METAL OXIDES TO FORM EUTECTIC COMPOSITES

(71) Applicant: Dow Corning Corporation, Midland, MI (US)

(72) Inventors: JEREMY BEEBE, Midland, MI (US); MATTHEW GAVE, Saginaw, MI (US); VASGEN SHAMAMIAN, Midland, MI (US); RANDALL SIEGEL, Midland, MI (US); JOSEPH SOOTSMAN, Freeland, MI (US); JAMES YOUNG, Midland, MI (US)

(21) Appl. No.: 14/527,159

(22) Filed: Oct. 29, 2014

Related U.S. Application Data
(63) Continuation of application No. PCT/US2013/041790, filed on May 20, 2013.
(60) Provisional application No. 61/649,681, filed on May 21, 2012.

(51) Int. Cl. C04B 35/657; C04B 35/58

(52) U.S. Cl. CPC C04B 35/657; C04B 35/58085; C04B 2235/652
USPC 501/96.3

(57) ABSTRACT

A method of making a eutectic alloy body by silicothermic reduction is provided. The method can include heating a mixture including silicon and a metal oxide comprising one or more metallic elements M and oxygen, forming a eutectic alloy melt from the mixture, and removing heat from the eutectic alloy melt, thereby forming the eutectic alloy body having a eutectic aggregation of a first phase comprising the silicon and a second phase being a silicide phase.

### CROSS-REFERENCE TO RELATED APPLICATIONS

This Application is a continuation of International Patent Application No. PCT/US2013/041790, filed May 20, 2013, which claims priority to U.S. Provisional Patent Application No. 61/649,681, filed May 21, 2012, both of which are incorporated by reference herein in their entirety.

### FIELD

The present disclosure is directed generally to eutectic alloys and more particularly to eutectic alloy compositions comprising silicon (Si).

### BACKGROUND

The statements in this section merely provide background information related to the present disclosure and may not constitute prior art.

Silicon eutectic compositions are of great technological interest as structural and wear resistant components. These “castable ceramic” materials can have similar mechanical properties to certain technical ceramics, including good wear resistance, corrosion behavior, toughness, and strength. For example, Si—CrSi₂ eutectic alloy composites have been studied and their mechanical properties are similar to or better than many technical ceramics. It has also been recognized that these alloys can be fabricated by melting and casting processes (see, e.g., WO 2011/022058).

### SUMMARY

Described herein are methods of using silicothermic reduction of metal oxides to fabricate silicon eutectic alloys. In addition, silicon eutectic alloys having one or more silicides are described according to the teaching of the present disclosure.

According to one aspect of the present disclosure, a method of making a eutectic alloy composition by silicothermic reduction is provided. The method can include heating a mixture including silicon and a metal oxide comprising one or more metallic elements M and oxygen, forming a eutectic alloy melt from the mixture, and removing heat from the eutectic alloy melt. The method can further include forming the eutectic alloy composition including the silicon, the one or more metallic elements M, and a eutectic aggregation of a first phase comprising the silicon and a second phase being a silicide phase. For example, the second phase may have a formula MSi₂ and the second phase may be a disilicide phase.

According to another aspect of the present disclosure, a silicon eutectic alloy composition is provided. The silicon eutectic alloy composition can include a body comprising a eutectic alloy having silicon, one or more metallic elements M, and a eutectic aggregation of a first phase comprising silicon and a second phase being a silicide phase. The body may further comprise a third phase comprising a metal oxide, wherein the metal oxide comprises the one or more metallic elements M.

The silicon eutectic alloy composition may be advantageously used in any of a number of industries, such as by way of example chemical, oil and gas, semiconductor, automotive, aerospace, machine parts and solar industries, among others, in which a component exhibiting good fracture toughness and wear resistance is desired.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a Cr—Si phase diagram obtained from ASM Alloy Phase Diagrams Center, P. Villars, editor-in-chief, H. Okamoto and K. Cenzual, section editors, ASM International, Materials Park, Ohio, USA, 2006-2011;

FIG. 2 is an optical microscope image of rod-like reinforcement phase structures aligned perpendicular to the surface of a eutectic alloy sample prepared by directional solidification;

FIGS. 3A-3B are powder X-ray diffraction patterns after reaction for (A) Si—Cr₂O₃ reaction products (using intimate mixtures and layered starting materials prior to reaction) and (B) Si—V₂O₅ reaction products showing only the presence of the desired silicon and MSi₂ reaction products where all X-ray diffraction patterns also indicate the presence of about 1-2% residual SiO₂ product from the associated fused silica reaction vessel; and

FIGS. 4A-4F are scanning electron microscope images of (A-B) Example 1 showing eutectic microstructure of the Si—CrSi₂ system with some primary grains of Si, (C-D) Example 2 showing a more homogeneous microstructure with similar eutectic structure to samples prepared from metallic Cr, and (E-F) Example 3 showing the Si—VSi₂ eutectic microstructure.

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally relates to methods of using silicon and metal oxides to produce silicon eutectic alloy compositions. The following specific embodiments are given to illustrate the design and use of silicon eutectic alloy compositions according to the teachings of the present disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

Direct processing and access to composite materials without first forming the metal starting components is of great interest for ease of processing and reduced raw material costs. In particular, direct production of Si eutectic alloys from a metal oxide and silicon provides a route to the eutectic alloy composite structure without the costly metal production process. Oxide prices are often only 5-10% of the cost of the metal starting materials. For example, currently in the case of chromium, 2 kg of metal would cost about $1100 while 2 kg of chromium oxide would cost about $100.

For certain silicon eutectic alloys, such as Si—CrSi₂ and Si—VSi₂, the resulting microstructure of the eutectic prepared with silicothermic reduction of the metal oxide MₓO_{y} (e.g., Cr₂O₃ or V₂O₅.) is indistinguishable from those where the metal M (e.g., chromium (Cr) or vanadium (V)) was used as a starting material. Powder X-ray diffraction results indicate the presence of only Si, MSi₂, and a small amount of SiO₂ from the reaction vessel. The mechanical properties, as a result of the similar microstructure, are expected to be similar to those of the materials prepared from metallic starting materials.

By way of background, general description of eutectic alloy compositions comprising silicon (Si) and a metallic element (M) are described below first. A eutectic reaction of the elements Si and M can be described as follows:

L [symbol] Si+MSi₂, or (1)

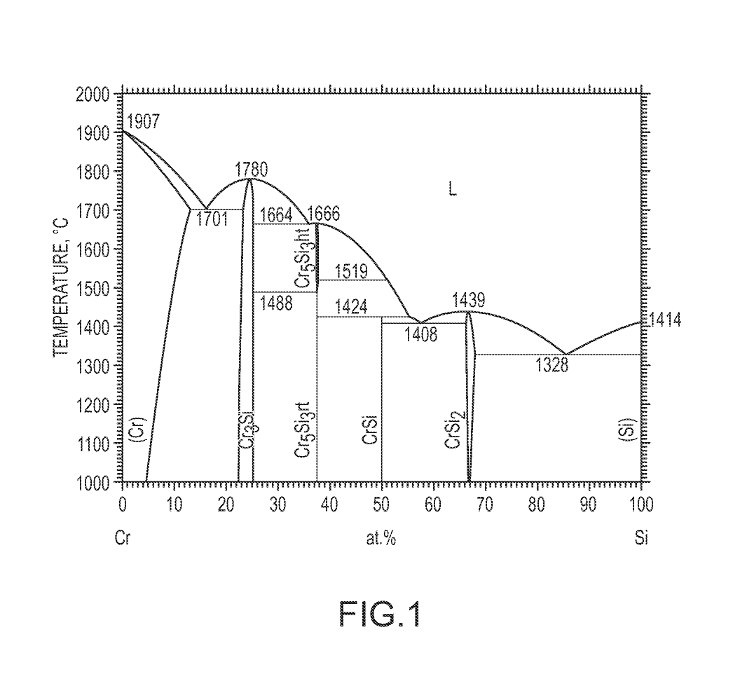

L [symbol] MₓSi_{y}+MSi₂, (2)

where a liquid phase (L) and two solid phases (e.g., Si and MSi₂ as in (1) or MₓSi_{y} and MSi₂ as in (2)) exist in equilibrium at a eutectic composition and the corresponding eutectic temperature. FIG. 1 is an example phase diagram illustrating a eutectic reaction of elements silicon and chromium. In the case of a binary eutectic alloy, the eutectic composition and eutectic temperature define an invariant point (or eutectic point). A liquid having the eutectic composition undergoes eutectic solidification upon cooling through the eutectic temperature to form a eutectic alloy composed of a eutectic aggregation of solid phases. Eutectic alloys at the eutectic composition melt at a lower temperature than do the elemental or compound constituents and any other compositions thereof.

The first phase may be an elemental silicon phase. For example, the elemental silicon phase may be in the form of crystalline silicon and/or amorphous silicon. The first phase may alternatively be an intermetallic compound phase. For example, the first phase may include silicon and the metallic element(s) M. The first phase may have a formula MₓSi_{y}, where x and y are integers. Generally, the intermetallic compound phase is different from the second phase. For example, if the second phase is a disilicide phase, x may not be 1 and y may not be 2.

The second phase or the silicide phase may be a disilicide phase of formula MSi₂. For example, the disilicide phase may be selected from the group consisting of CrSi₂, VSi₂, WSi₂, MgSi₂, NbSi₂, TaSi₂, TiSi₂, MoSi₂, CoSi₂, ZrSi₂, HfSi₂, MnSi₂, NiSi₂, and ReSi₂.

The eutectic aggregation may have a morphology that depends on the solidification process. The eutectic aggregation may have a lamellar morphology including alternating layers of the solid phases (e.g., first and second phases), which may be referred to as matrix and reinforcement phases, depending on their respective volume fractions, where the reinforcement phase is present at a lower volume fraction than the matrix phase. In other words, the reinforcement phase is present at a volume fraction of less than 0.5. The reinforcement phase may comprise discrete eutectic structures, whereas the matrix phase may be substantially continuous. For example, the eutectic aggregation may include a reinforcement phase of rod-like, plate-like, acicular and/or globular structures dispersed in a substantially continuous matrix phase. Such eutectic structures may be referred to as “reinforcement phase structures.”

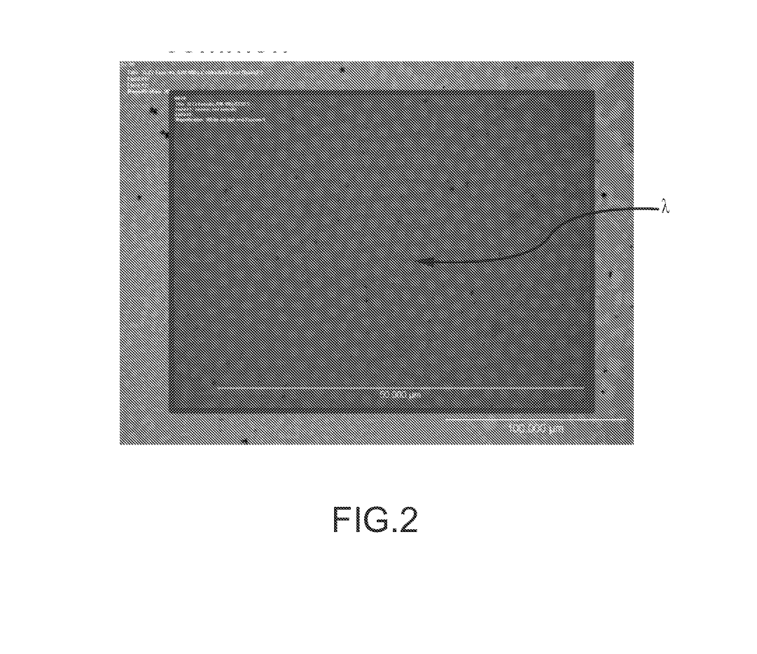

The reinforcement phase structures in the eutectic aggregation may further be referred to as high aspect ratio structures when at least one dimension (e.g., length) exceeds another dimension (e.g., width, thickness, diameter) by a factor of by a factor of 2 or more. Aspect ratios of reinforcement phase structures may be determined by optical or electron microscopy using standard measurement and image analysis software. The solidification process may be controlled to form and align high aspect ratio structures in the matrix phase. For example, when the eutectic alloy is produced by a directional solidification process, it is possible to align a plurality of the high aspect ratio structures along the direction of solidification, as shown for example in FIG. 2, which shows an optical microscope image of rod-like structures aligned perpendicular to the surface of an exemplary Si—CrSi₂ eutectic alloy sample (and viewed end-on in the image).

According to one aspect of the present disclosure, a method of making a eutectic alloy composition by silicothermic reduction is provided. The method can include heating a mixture including silicon and a metal oxide comprising one or more metallic elements M and oxygen and forming a eutectic alloy melt from the mixture.

The elemental silicon and metal oxide can be mixed together to form the mixture. Although the mixture may be a substantially homogeneous distribution of particles or powder of silicon and metal oxide, the term “mixture” should not be construed to mean as such. For example, the mixture may include a layer of silicon adjacent to a layer of metal oxide.

The metal oxide can include one or more metallic elements M and oxygen. For example, the one or more metallic elements M comprises at least one element selected from the group consisting of chromium, vanadium, tungsten, magnesium, niobium, tantalum, and titanium. Other possible metallic elements M include, but are not limited to, manganese, cobalt, hafnium, molybdenum, nickel, rhenium, and zirconium. The metal oxide may have the formula MₓO_{y}, where x and y are integers. For example, the metal oxide may include Cr₂O₃ or V₂O₅.

The elemental silicon can include other elements for alloying or can be a relatively high purity. As such, the elemental silicon can include a wide variety of impurities. For example, the elemental silicon can be chemical grade, metallurgical grade, solar grade, electronic grade, semi-conductor grade, or ultra-high purity. For example, the elemental silicon can have a purity of at least about 95%, at least about 99%, at least about 99.9%, or about 95% to about 99% by weight. Furthermore, the elemental silicon can include alloying elements such as iron (e.g., ferrosilicon), boron, aluminum, calcium, etc. As such, a lower purity of silicon can be a means for including alloying elements. Furthermore, the mixture may include one or more additional alloying elements.

The method includes heating the mixture to a temperature sufficient to result in silicothermic reduction of the metal oxide to form the eutectic composition (e.g., eutectic alloy melt). A first portion of the silicon in the mixture reduces the metal oxide to metallic element M while a second portion of the silicon in the mixture forms the silicon of the resulting silicon eutectic composite. As such, the forming of the eutectic alloy melt may include reduction of the metal oxide by the silicon.

The silicothermic reduction of metal oxides can be described by the following reaction:

ySi+MₓO_{y}→ySiO(g)+xM,

where Si is silicon, O is oxygen, M is a metallic element, x is an integer, and y is an integer. After the reduction of the metal oxide, the metallic element and silicon form a eutectic alloy composition.

The silicon can form SiO(g) with the oxygen of the metal oxide resulting in the reduced metallic element M. Therefore, the starting amount of silicon in the mixture can be selected such that desired composition of the silicon eutectic composite results after the metal oxide has been substantially reduced. For example, the mixture may include a first silicon atomic concentration and the eutectic alloy composition may include a second silicon atomic concentration less than the first silicon atomic concentration. Furthermore, the first silicon atomic concentration may be selected so that the eutectic alloy composition consists essentially of the eutectic aggregation.

In one illustrative example, in order to prepare 20 g of eutectic product comprising Si and CrSi₂, the relative amounts of Cr and Si are determined by the phase diagram (FIG. 1). The appropriate mixture contains 76%/24% weight ratio of Si/Cr; therefore, the desired amounts are 15.2 g and 4.8 g of Si and Cr from Cr₂O₃, respectively. According to the balanced equation of

$$4 Si + {Cr}_{2} {O}_{3} {}^{Δ} 2 Cr + Si + 3 SiO ( g ) ,$$

this will produce 6.1 g of SiO during the reaction. To account for the loss of Si as SiO, 19.08 g of Si and 7.0144 g of Cr₂O₃ are used as the starting materials.

The silicothermic reduction can be performed at a temperature at least as high as the melting temperature of the resulting eutectic alloy composition to form the eutectic alloy melt from the mixture. For example, the mixture may be heated to a temperature at or above the eutectic temperature, to a superheat temperature such as greater than about 50° C. above the eutectic temperature, or to a temperature greater than about 1475° C. or greater than about 1500° C. The mixture can be kept at such a temperature until substantially all of the metal oxide has been reduced and the melt to homogenize. For example, the mixture may be heated to the temperature for at least about 5 minutes.

The metal oxide may be more stable than silicon oxide. However, some SiO(g) will still form under a closed system in equilibrium. Therefore, if the SiO(g) is removed from the system, SiO(g) will continue to form. As such, the reduction of the metal oxide can result in evolution of silicon oxide gas such as silicon monoxide. Furthermore, silicon oxide gas can be removed from being in chemical interaction with the mixture. For example, reduction of the metal oxide can take place in a vacuum environment or other suitable environment such as an inert environment to preferentially remove SiO from the mixture. For example, the vacuum environment may be an environment maintained at a pressure of about 10⁻⁴ Torr (about 10⁻² Pa) or lower (where a lower pressure correlates to a higher vacuum). The vacuum environment may also be maintained at a pressure of about 10⁻⁵ Torr (10⁻³ Pa) or lower and greater than 0 Pa.

As a result of the SiO(g) evolution, the mixture can have a first mass, and the eutectic alloy composition can have a second mass less than the first mass. The metal oxide may be substantially completely reduced such that the eutectic alloy composition is substantially free of oxides. For example, the eutectic alloy composition may have less than 1 atomic percent of oxides.

The heating of the mixture may take place in a variety of containers such as carbon (e.g., graphite or glassy carbon) or quartz. The container may be select so that it substantially does not include a metal oxide that may be reduced such that the metal of the metal oxide of the container enters the eutectic alloy melt. For example, a container with alumina may be reduced resulting in aluminum in the eutectic alloy melt.

After reduction of the metal oxide, the method can further include removing heat from the eutectic alloy melt to solidify the eutectic alloy melt, thereby forming the eutectic alloy composition. Heat may be removed by a number of methods. For example, directional solidification of a eutectic alloy melt may be used. In addition, the eutectic alloy melt can be cooled at a variety of rates depending on desired microstructure. For example, the eutectic alloy melt may be cooled at a rate of at least about 10° C. per minute.

Furthermore, the eutectic alloy melt may be transferred from the container (e.g., crucible) where the heating of the mixture took place to a mold where the eutectic alloy melt is cooled to form a casting. Alternatively, the eutectic alloy melt may be allowed to cool and solidify, and later, the eutectic alloy may be re-melted and cast.

The eutectic alloy composition can include the silicon, the one or more metallic elements M, and a eutectic aggregation of a first phase comprising the silicon and a second phase being a silicide phase. After the metal oxide is reduced to a metal, the elements Si and M can form a liquid phase which upon cooling can go through a eutectic reaction to form the eutectic aggregation.

According to another aspect of the present disclosure, all the metal oxide may not be reduced to the metal. For example, the silicon eutectic alloy composition may include a third phase having a portion of the metal oxide. According to one aspect of the present disclosure, a silicon eutectic alloy composition may comprise a body comprising a eutectic alloy including silicon, one or more metallic elements M, and a eutectic aggregation of a first phase comprising silicon and a second phase being a silicide phase. The body can further include a third phase comprising a metal oxide, where the metal oxide comprises the one or more metallic elements M. The third phase may provide improve one or more properties of the silicon eutectic alloy composition such as fracture toughness.

The following examples are provided to demonstrate the benefits of the disclosed methods of using silicothermic reduction of metal oxides to form silicon eutectic composites.

### EXAMPLE 1: Si—Cr₂O₃ MIXTURE

14.3192 g of Silicon (PV1101, Dow Corning, Solar Grade) and 5.2619 g of Chromium (III) oxide (Sigma Aldrich, 99.98%) were layered in a quartz crucible. The quartz crucible was then placed inside a graphite susceptor and loaded into a vacuum system with cooled end caps. The system was evacuated to 1.9E-5 Torr. Power was applied to an Ameritherm 15 kW induction heater with a ramp time of 205 minutes to reach a melt temperature of 1550° C. The melt temperature was maintained at 1550° C. ±15° C. for 60 minutes by careful monitoring and adjusting of the input voltage. Cooling of the melt was performed by turning off the power to the induction heater.

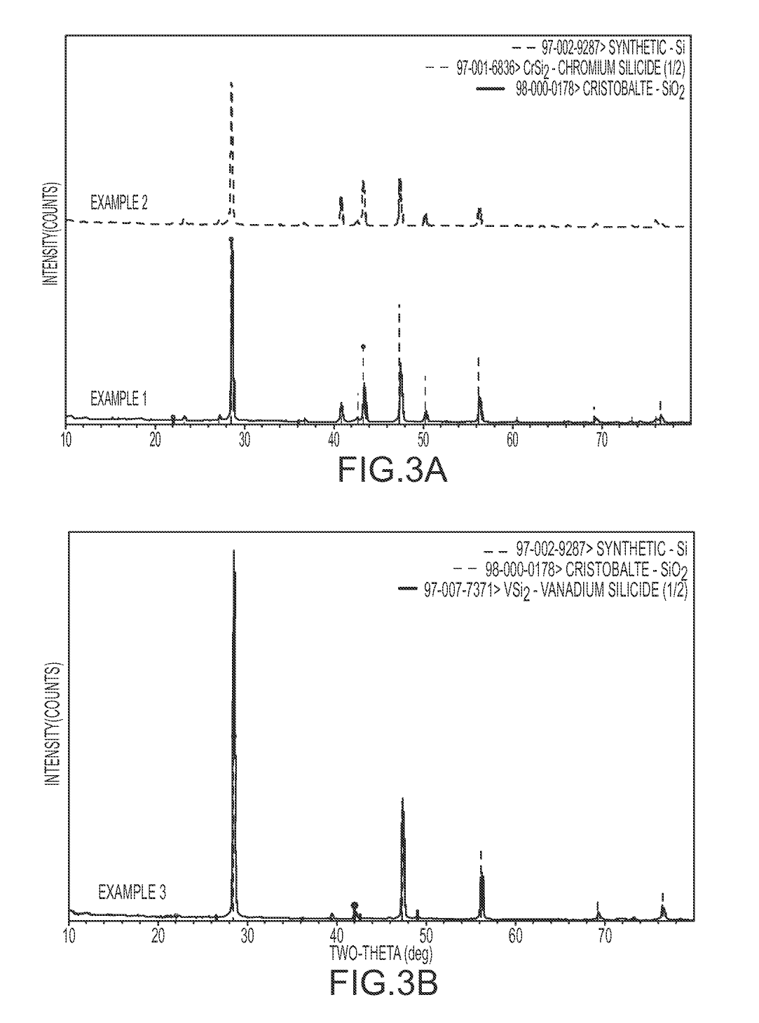

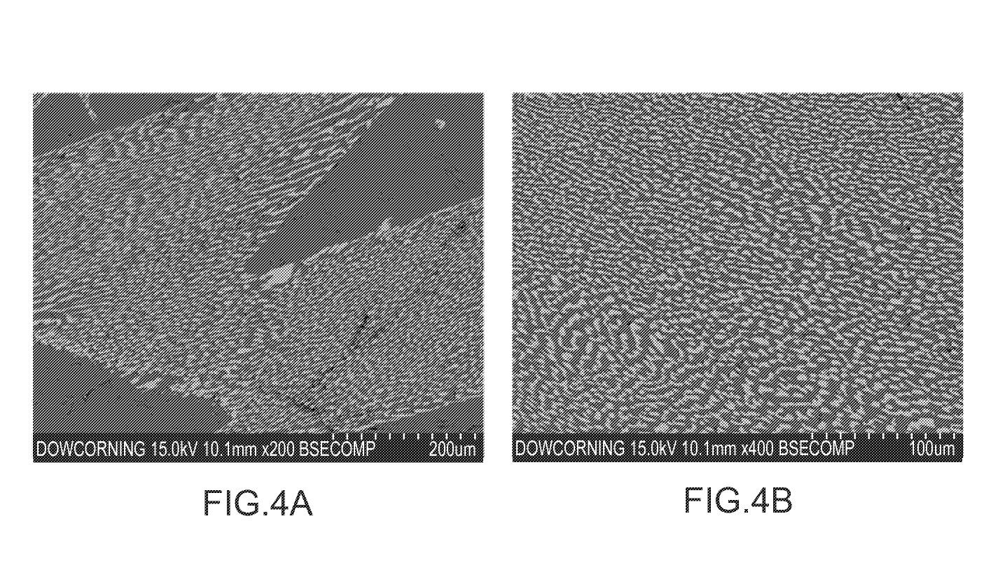

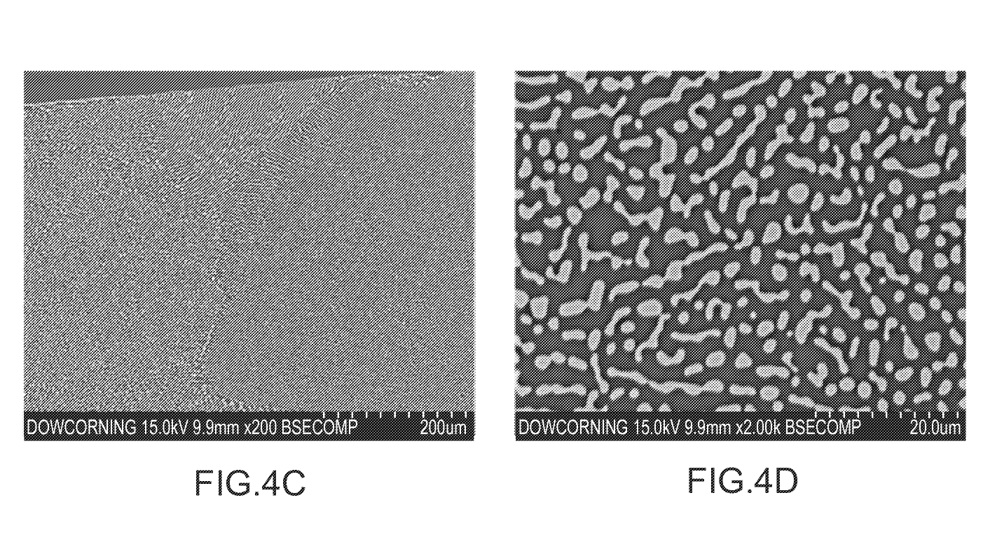

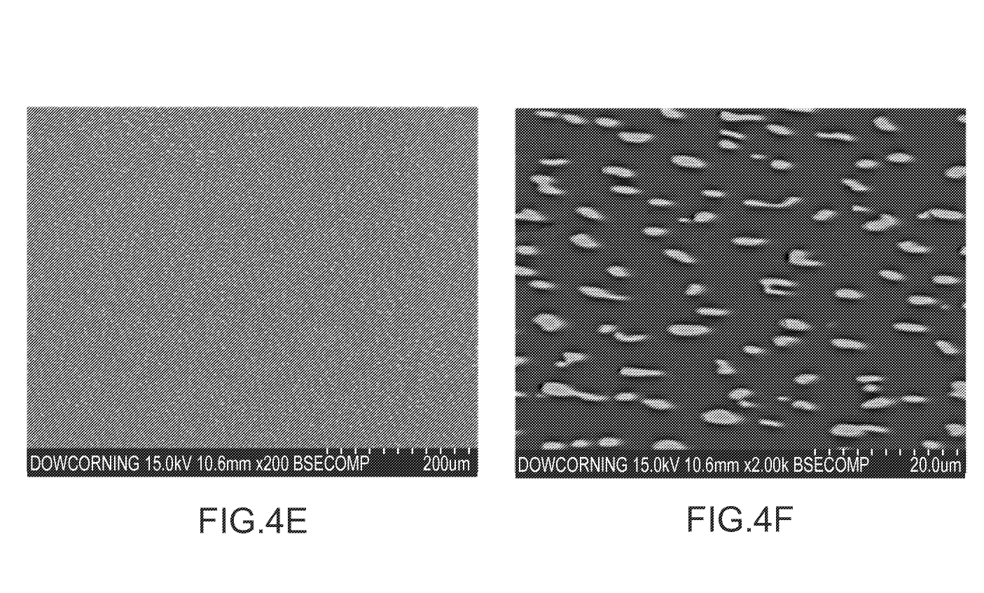

Once cool, the resulting material was removed from the quartz liner although some residual quartz was present on the surface of the ingot. Total ingot yield from the reaction was 11.9 g corresponding to a 79% product yield. The significant amount of SiOₓ formed during reaction condensed on the cooled end cap of the reactor. The resulting ingot product was analyzed by X-ray diffraction indicating the presence of the desired silicon and CrSi₂ reaction products and residual SiO₂ product from the associated fused silica reaction vessel, as shown by FIG. 3A. Scanning electron microscopy indicated a eutectic microstructure of the Si—CrSi₂ system with some primary grains of Si, as shown by FIGS. 4A-4B.

### EXAMPLE 2Si—Cr₂O₃ MIXTURE

19.0898 g of Silicon (PV1101, Dow Corning, Solar Grade) and 7.0155 g of Chromium (III) oxide (Sigma Aldrich, 99.98%) were evenly mixed in a quartz crucible. The quartz crucible was then placed inside a graphite susceptor and loaded into a vacuum system with cooled end caps. The system was evacuated to 2.5E-6 Torr. Power was applied to an Ameritherm 15 kW induction heater with a ramp time of 215 minutes to reach a melt temperature of 1471° C. The melt temperature was maintained at 1475° C.±10° C. for 60 minutes by careful monitoring and adjusting of the input voltage. Cooling of the melt was performed by turning off the power to the induction heater.

Once cool, the resulting material was removed from the quartz liner although some residual quartz was present on the surface of the ingot. Total ingot yield from the reaction was 12.0724 g corresponding to a 60% product yield. The significant amount of SiOₓ formed during reaction condensed on the cooled end cap of the reactor. The resulting ingot product was analyzed by X-ray diffraction indicating the presence of silicon, CrSi₂, and residual SiO₂, as shown by FIG. 3A, and analyzed by scanning electron microscopy showing a more homogeneous microstructure with similar eutectic structure to samples prepared from metallic chromium, as shown by FIGS. 4C-4D.

### EXAMPLE 3: Si—V₂O₅ MIXTURE

20.4023 g of Silicon (PV1101, Dow Corning, Solar Grade) and 1.8916 g of Vanadium (IV) oxide (Sigma Aldrich, 99.98%) were evenly mixed in a quartz crucible. The quartz crucible was then placed inside a graphite susceptor and loaded into a vacuum system with cooled end caps. The system was evacuated to 3.6E-6 Torr. Power was applied to an Ameritherm 15 kW induction heater with a ramp time of 220 minutes to reach a melt temperature of 1521° C. The melt temperature was maintained at 1520° C.±10° C. for 60 minutes by careful monitoring and adjusting of the input voltage. Cooling of the melt was performed by turning off the power to the induction heater.

Once cool, the resulting material was removed from the quartz liner although some residual quartz was present on the surface of the ingot. Total ingot yield from the reaction was 20.9700 g corresponding to a 104% product yield. The higher than expected yield is likely caused by residual quartz that was not removed from the ingot surface. The significant amount of SiOₓ formed during reaction condensed on the cooled end cap of the reactor. The resulting ingot product was analyzed by X-ray diffraction indicating Si—V₂O₅ reaction products showing the presence of the desired silicon and MSi₂ reaction products and the presence of about 1-2% residual SiO₂ product, as shown by FIG. 3B, and analyzed by scanning electron microscopy showing the Si—VSi₂ eutectic microstructure, as shown by FIGS. 4E-4F.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of making a eutectic alloy body by silicothermic reduction, the method comprising:
heating a mixture including silicon and a metal oxide comprising one or more metallic elements M and oxygen;
forming a eutectic alloy melt from the mixture;
removing heat from the eutectic alloy melt, thereby forming the eutectic alloy body the eutectic alloy body having a eutectic aggregation of a first phase comprising the silicon and a second phase being a silicide phase, the silicide phase comprising a metallic element M of the metal oxide.

2. The method of claim 1, wherein the forming of the eutectic alloy melt comprises reducing the metal oxide by the silicon.

3. The method of claim 2, wherein the reducing step comprises evolving silicon oxide gas.

4. The method of claim 3, comprising removing the silicon oxide gas from being in chemical interaction with the mixture.

5. The method of claim 4, wherein the silicon oxide gas comprises silicon monoxide.

6. The method of claim 5, wherein the mixture comprises a first silicon atomic concentration and the eutectic alloy body comprises a second silicon atomic concentration less than the first silicon atomic concentration.

7. The method of claim 6, wherein the first silicon atomic concentration is selected so that the eutectic alloy body consists essentially of the eutectic aggregation.

8. The method of claim 7, wherein the eutectic alloy body comprises less than 1 atomic percent of oxides.

9. The method claim 1, wherein the eutectic alloy body further includes a third phase comprising a portion of the metal oxide.

10. The method of claim 1, wherein the metallic elements M comprises at least one element selected from the group consisting of chromium, vanadium, tungsten, manganese, magnesium, niobium, tantalum, and titanium.

11. The method of claim 1, wherein the second phase is of formula MSi₂ and the second phase being a disilicide phase.

12. The method of claim 11, wherein the first phase is an elemental silicon phase and wherein the disilicide phase is selected from the group consisting of CrSi₂, VSi₂, NbSi₂, TaSi₂, MgSi₂, MoSi₂, WSi₂, CoSi₂, TiSi₂, ZrSi₂, and HfSi₂.

13. The method of claim 1, wherein the mixture comprises one or more additional alloying elements.

14. The method of claim 1, wherein the silicon comprises solar grade silicon.

15. A silicon eutectic alloy composition comprising:
a body comprising a eutectic alloy including silicon, one or more metallic elements M, and a eutectic aggregation of a first phase comprising silicon and a second phase being a silicide phase, and a third phase comprising a metal oxide, wherein the metal oxide comprises the one or more metallic elements M, and wherein the body comprises at least 1 wt. % of the metal oxide.
